(19) United States
(12) Patent Application Publication
(10) Pub. No.: US 2021/0327439 A1
(43) Pub. Date: Oct. 21, 2021

(54) Audio data recovery method, device and Bluetooth device

(71) Applicant: Nanjing Zgmicro Company Limited, Nanjing (CN)

(72) Inventors: Haiye WANG, Nanjing (CN); Yuhong FENG, Nanjing (CN); Xiaodong YANG, Nanking (CN); Zhandong GAO, Nanjing (CN); Yinong ZHANG, Nanjing (CN); Yan XIONG, Nanjing (CN)

(21) Appl. No.: 17/359,602

(22) Filed: Jun. 27, 2021

Related U.S. Application Data
(63) Continuation of application No. PCT/CN2019/128783, filed on Dec. 26, 2019.

(30) Foreign Application Priority Data
Dec. 28, 2018 (CN) 201811623219.1

(51) Int. Cl. G10L 19/005; G10L 19/022; G10L 19/06; H04W 4/80

(52) U.S. Cl. CPC G10L 19/005; H04W 4/80; G10L 19/06; G10L 19/022

(57) ABSTRACT

An audio data recovery method, an audio data recovery device and a Bluetooth device are described in the present invention. The audio data recovery method comprises: receiving audio data in time domain, the audio data including a first type of data and a second type of data; transforming the audio data from the time domain into frequency domain to produce transformed first type of data and transformed second type of data; performing packet loss concealment estimation on the transformed second type of data to generate estimated second type of data in the frequency domain; transforming inversely the transformed first type of data together with the estimated second type of data from the frequency domain to the time domain; and obtaining recovered audio data in the time domain according to the first type of data in the audio data in the time domain and the estimated second type of data in the time domain.

### CROSS-REFERENCES TO RELATED APPLICATIONS

This patent application is a continuation of PCT/CN2019/128783 filed Dec. 26, 2019, which claims the priority of Chinese Patent Application No.: 201811623219.1, filed on Dec. 28, 2018 in China, the entire content of which is incorporated herein by reference.

### BACKGROUND OF THE INVENTION

### Field of the Invention

The present disclosure relates to the field of Bluetooth technology, and in particular to an audio data recovery method, an audio data recovery device, and a Bluetooth device.

### Description of the Related Art

Bluetooth audio transmission means that a Bluetooth audio transmitter transmits audio data packets to a Bluetooth audio receiver through a wireless connection channel. Because Bluetooth is a wireless connection, some audio data packets sent by an audio transmitter may not be received correctly by an audio receiver when the interference is large or the connection distance is long. That is to say, there are audio data packets that have been lost in transit. The loss of the audio data packets would significantly degrade the audio quality.

FIG. 1 is a schematic flow diagram showing a process of audio data received by a Bluetooth receiver in the prior art. As shown in FIG. 1, the Bluetooth receiver usually decodes the received audio data to obtain time domain data (PCM data), then performs packet loss compensation, and finally play the audio data.

In order to solve the problem of audio data packet loss, a packet concealment technology based on the audio data at the receiving end is usually used in a prior art system that may use noise replacement, waveform replacement, packet repetition and etc. Some advanced systems may use advanced estimation algorithms including interpolation in a compressed domain, sine audio modeling interpolation and so on. There is an audio data recovery method based on Gapped-data Amplitude and Phase Estimation (GAPES) algorithm to recovery audio data. Specifically, the audio data recovery method based on the GAPES recoveries audio data by transforming the data in time domain to the frequency domain. Compared with other methods commonly used, the method based on the GAPES algorithm has significantly improved the quality of packet loss concealment, and it has a good effect even at a 30% packet loss rate.

However, the method based on the GAPES algorithm for recovering the audio data is high in complexity and low in accuracy. Therefore, there is a need for an improved technical solution to solve the above-mentioned problems.

### SUMMARY OF THE INVENTION

An audio data recovery method, an audio data recovery device and a Bluetooth device are provided according to embodiments of the present invention to solve at least the above technical problems.

According to one aspect of the present invention, an audio data recovery method comprises: receiving audio data in time domain, the audio data including a first type of data and a second type of data; transforming the audio data from the time domain into frequency domain to produce transformed first type of data and transformed second type of data; performing packet loss concealment estimation on the transformed second type of data to generate estimated second type of data in the frequency domain; transforming inversely the transformed first type of data together with the estimated second type of data from the frequency domain to the time domain; and obtaining recovered audio data in the time domain according to the first type of data in the audio data in the time domain and the estimated second type of data in the time domain.

According to another aspect of the present invention, an audio data recovery device, comprises: a receiving module configured for receiving time domain audio data comprising a first type of data and a second type of data; a transform module configured for transforming the time domain audio data into frequency domain audio data; an estimation module configured for performing packet loss concealment estimation on a part, obtained by transforming the second type of data, of the frequency domain audio data to generate estimated frequency domain audio data, and transforming the estimated frequency domain audio data into estimated time domain audio data; and a recovery module configured for obtaining recovered time domain audio data according to the first type of data in the time domain audio data and the estimated time domain audio data.

According to another aspect of the present invention, a Bluetooth device comprises an audio data recovery device. The audio data recovery device comprises: a receiving module configured for receiving time domain audio data including a first type of data and a second type of data; a transform module transforming the time domain audio data into frequency domain audio data to produce transformed first type of data and transformed second type of data; an estimation module performing packet loss concealment estimation on the transformed second type of data, transforming the estimated frequency domain audio data into estimated time domain audio data; and a recovery module configured for obtaining recovered time domain audio data according to the first type of data in the time domain audio data and the estimated time domain audio data.

One of the advantages, features or advantages of the present invention is that only a part, obtained by transforming the second type of data, of the frequency domain audio data is estimated by packet loss concealment estimation, and an output result with a higher accuracy than a traditional method based on the GAPES algorithm can be obtained by combining a first part of the first type of data in the time domain audio data without any transformation processing and the estimated time domain audio data. Furthermore, it has lower computational complexity than the traditional method.

There are many other objects, together with the foregoing attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings wherein:

FIG. 1 is a schematic flow diagram showing a processing process of audio data received by a Bluetooth receiver in the related technology;

FIG. 2 is a schematic diagram of an implementation process of the traditional audio data recovery method based on GAPES algorithm in time-frequency domains;

FIG. 3 is a flowchart of an audio data recovery method according to one embodiment of the present invention;

FIG. 4 is a schematic diagram of an implementation process of the audio data recovery method in time-frequency domains according to one embodiment of the present invention;

FIG. 5 is a schematic structural diagram of an audio data recovery device according to one embodiment of the present invention; and

FIG. 6 is a schematic structural diagram of a Bluetooth device according to one embodiment of the present invention.

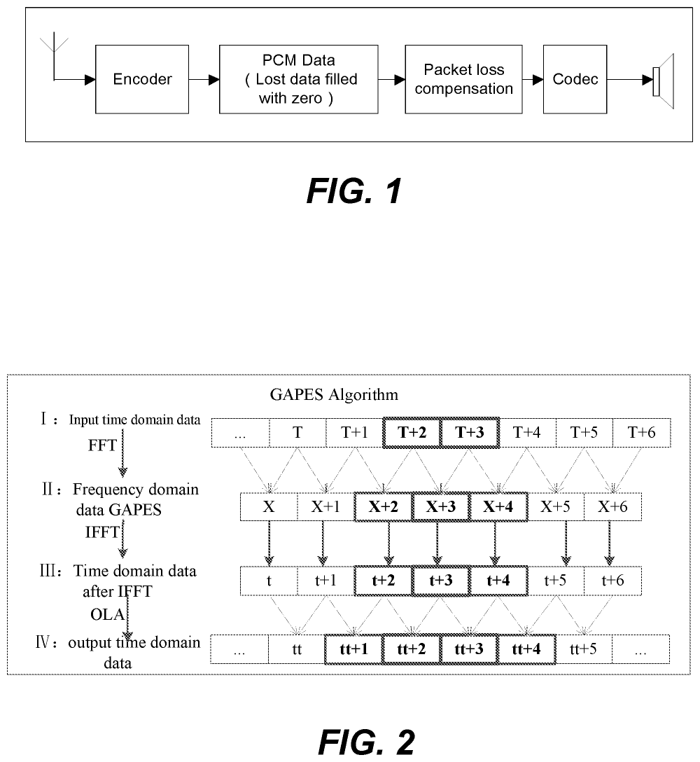

### DETAILED DESCRIPTION OF THE PREFERRED EMBODIMENTS

The detailed description of the invention is presented largely in terms of procedures, operations, logic blocks, processing, and other symbolic representations that directly or indirectly resemble the operations of data processing devices that may or may not be coupled to networks. These process descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be comprised in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

FIG. 2 is a schematic diagram of an implementation of an audio data recovery method based on GAPES algorithm in time-frequency domains. As shown in FIG. 2, time domain data (data I) is transformed into frequency domain data (data II) through discrete Fast Fourier Transformation (FFT). As shown in the FIG. 2, it is supposed that T, T+1, T+4, T+5 and T+6 are good data packets, and T+2 and T+3 are lost or bad data packets (displayed in bold). After being transformed into the frequency domain, X, X+1, X+5 and X+6 are the frequency domain data obtained by the FFT transformation of the good data packets, and X+2, X+3 and X+4 are the frequency domain data obtained by the FFT transformation and the packet loss concealment estimation (based on the GAPES algorithm) of the lost or bad data packets.

The GAPES algorithm is then provided to perform a packet loss concealment estimation on the frequency domain data (data II), and the frequency domain data obtained after the packet loss concealment estimation processing is transformed into the time domain data (data III) by the discrete Inverse Fast Fourier Transform (IFFT). Finally, the time domain data (data III) is processed by an overlap-add (OLA) to obtain the final time domain data (data IV) which is output to a CODEC.

The GAPES-based algorithm shown in FIG. 2 is not suitable for application in embedded real-time systems due to the huge amount of calculation. It has low accuracy due to the loss of the accuracy caused by transformation between the time domain and the frequency domain.

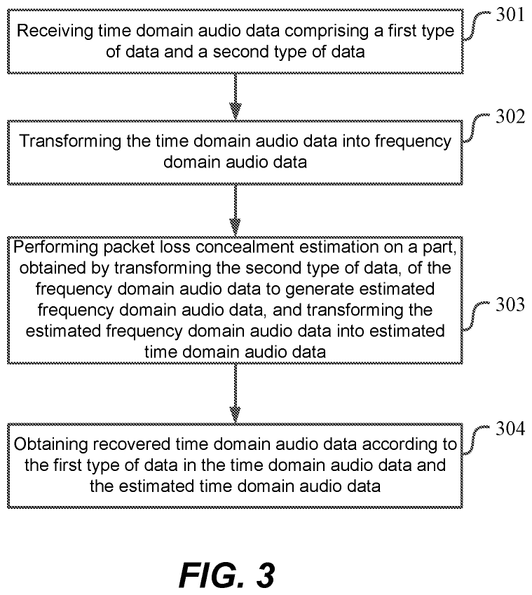

FIG. 3 is a flowchart of an audio data recovery method according to one embodiment of the present invention. As shown in FIG. 3, the audio data recovery method comprises: receiving time domain audio data including a first type of data and a second type of data at 301. The time domain audio data is transformed into frequency domain audio data at 302. Correspondingly, there are transformed first and second types of data (i.e., first type of data in frequency domain and second type of data in frequency domain). The packet loss concealment estimation is performed only on some of the transformed data. According to one embodiment, the packet loss concealment estimation is performed on the second type of data in frequency domain. Then the first type of data in frequency domain and the processed second type of data in frequency domain are inversely transformed back to the time domain at 303. The time domain audio data is recovered according to the first type of data in the time domain and the processed second type of data in the time domain at 304.

The audio data received in a receiving end is in the time domain so the audio data in the time domain needs to be transformed to the frequency domain when the audio data is processed. In one embodiment of the present invention, the packet loss concealment estimation is performed on a part, obtained by transforming the second type of data, of the frequency domain audio data to generate estimated frequency domain audio data. Then, the estimated frequency domain audio data is inversely transformed into the estimated time domain audio data. Finally, the audio data is recovered according to the first type of data in the time domain audio data and the estimated time domain audio data.

According to the embodiment, only a part of the audio data, obtained by transforming the second type of data, not all of the frequency domain audio data is estimated by the packet loss concealment estimation, and an output result with a higher accuracy than the traditional method based on the GAPES algorithm can be obtained by combining a first part of the first type of data without any transformation processing and the estimated time domain audio data. Furthermore, it has lower computational complexity than the traditional method.

In one embodiment, the first type of data is correct data packets, and the second type of data is lost or error data packets. The received audio data can be CRC checked firstly. The data packet with correct CRC check in the received audio data is considered as the correct data packet, and the data packet with incorrect CRC check in the received audio data is considered as the error data packet. In addition, some data packets may be lost during transmission. The correct data packets are buffered, and the lost or error data packets are estimated based on the packet loss concealment estimation algorithm. Finally, the buffered correct data packet and the estimated data are processed to obtain the recovered audio data.

In one embodiment, the time domain audio data is transformed into the frequency domain audio data through discrete Fast Fourier Transform (FFT). In other embodiments, other transformation methods can also be used, which is not limited in the present invention.

In one embodiment, the Gapped-data Amplitude and Phase Estimation (GAPES) algorithm is used to perform the packet loss concealment estimation on the part, obtained by transforming the second type of data, of the frequency domain audio data. The GAPES algorithm is used in the present invention because the recovered audio quality obtained based on the GAPES algorithm is relatively higher. Those skilled in the art can also use other algorithms to perform the packet loss concealment estimation, which is not limited in the present invention.

In one embodiment, the obtaining recovered time domain audio data according to the first type of data in the time domain audio data and the estimated time domain audio data at 304 comprises: outputting a first part, not adjacent to the second type of data, of the first type of data in the time domain audio data directly as a first output result; performing an overlap-add OLA on a second part, adjacent to the second type of data, of the first type of data in the time domain audio data and the estimated time domain audio data to obtain and output a second output result; and obtaining the recovered audio data according to the first output result and the second output result.

In the present invention, the first part, that is not adjacent to the second type of data (bad data), of the first type of data (good data) is directly output without any transformation to ensure the highest accuracy. In addition, only the part, obtained by transforming the second type of data, of the frequency domain audio data is estimated based on the packet loss concealment estimation. The second part, that is adjacent to the second type of data (bad data), of the first type of data (good data) and the estimated time domain audio data are overlap-added and output, so as to ensure the higher accuracy than the traditional method. The output of the two parts finally forms the recovered audio data.

In one embodiment, the estimated time domain audio data has data blocks overlapped with the second part of the first type of data and data blocks not overlapped with the second part of the first type of data. The performing an overlap-add OLA on a second part, adjacent to the second type of data, of the first type of data in the time domain audio data and the estimated time domain audio data to obtain and output a second output result comprises: performing the overlap-add on the data blocks, overlapped with the second part of the first type of data, in the estimated time domain audio data and the second part of the first type of data to obtain and output a first correct data; performing the overlap-add among the data blocks in the estimated time domain audio data to obtain and output a second correct data; and combining the first correct data and the second correct data according to data serial number to obtain the second output result.

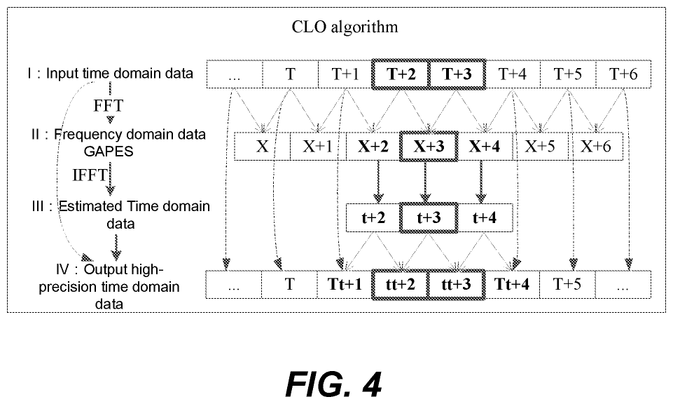

For example, as shown in FIG. 4, the second part, adjacent to the second type of data (T+2, T+3), of the first type of data in the time domain audio data comprises data packets T+1 and T+4, and wherein T+1 includes 1-128 data blocks, and T+4 includes 1-128 data blocks. The estimated time domain audio data comprises t+2, t+3 and t+4, and wherein t+2 includes 1-256 data blocks, t+3 includes 1-256 data blocks, and t+4 includes 1-256 data blocks.

In this example, the performing the overlap-add OLA on the second part T+1, T+4 of the first type of data in the time domain audio data and the estimated time domain audio data t+2, t+3, t+4 comprises: performing the overlap-add on the data blocks (the first data blocks 1-128 in t+2) overlapped with the second part (e.g. data blocks 1-128 in T+1) of the first type of data and the second part (data blocks 1-128 in T+1) of the first type of data to obtain and output Tt+1; performing the overlap-add on the data blocks (the last data blocks 129-256 in t+4) overlapped with the second part (data blocks 1-128 in T+4) of the first type of data and the second part (data blocks 1-128 in T+4) of the first type of data to obtain and output Tt+4; performing the overlap-add on the last data blocks 129-256 in t+2 and the first data blocks 1-128 in t+3 to obtain and output tt+2; performing the overlap-add on the last data blocks 129-256 in t+3 and the first data blocks 1-128 in t+4 to obtain and output tt+3; and combining Tt+1 and Tt+4 regarding as the first correct data and tt+2 and tt+3 regarding as the second correct data according to data serial number to obtain the second output result Tt+1, tt+2, tt+3, and Tt+4.

In one embodiment, the performing the overlap-add on the data blocks, overlapped with the second part of the first type of data, in the estimated time domain audio data and the second part of the first type of data to obtain and output a first correct data comprises: multiplying the second part of the first type of data in the time domain audio data by a first window coefficient to obtain a first data; multiplying the data blocks, overlapped with the second part of the first type of data, in the estimated time domain audio data by a second window coefficient to obtain a second data; and adding the first data obtained by multiplying the first window coefficient and the second data obtained by multiplying the second window coefficient to obtain the first correct data.

FIG. 4 is a schematic diagram of an implementation process of the audio data recovery method in the time-frequency domains according to one embodiment of the present invention.

First, the time domain data I is transformed to the frequency domain through FFT to obtain the frequency domain data II. As shown in FIG. 4, T, T+1, T+4, T+5, and T+6 in the time domain data I are correct data packets, T+2 and T+3 in the time domain data I are lost or error data packets; X, X+1, X+5, X+6 in the frequency domain data II represent the frequency domain data obtained by FFT transformation of the correct data packets, X+2, X+3, X+4 in the frequency domain data II represent the frequency domain data obtained by the FFT transformation and the packet loss concealment estimation of the lost or error data packets. The GAPES algorithm is used to perform the packet loss concealment estimation.

Then, the frequency domain data X+2, X+3, and X+4 estimated by the GAPES algorithm based on the lost or error data packets are transformed through IFFT to obtain the estimated time-domain data III including t+2, t+3 and t+4.

Finally, the high-precision time-domain data IV is obtained by combining a part of the time-domain data I and the estimated time-domain data III.

The correct data T, T+5, T+6 that are not adjacent to the lost or error data in the time domain data I are output directly. The correct data T+1, T+4 that is adjacent to the lost or error data in the time domain data I and the estimated time domain data t+1, t+3, t+4 are overlap-added to get Tt+1, tt+2, tt+3, and Tt +4.

The Tt+1 is got by the overlap-add of T+1 and t+2. The Tt+4 is got by the overlap-add of t+4 and T+4. The tt+2 is got by the overlap-add of data blocks t+2 and t+3. The tt+3 is got by the overlap-add of data blocks t+3 and t+4. Then, Tt+1, tt+2, tt+3, Tt+4 are combined according to the data sequence number.

Finally, Tt+1, tt+2, tt+3, Tt+4 are combined with T, T+5, and T+6 to get the final recovered data.

Assuming that when the data I is transformed to the data II, FFT is windowed by 50%, and when the data II is transformed to the data III, IFFT is windowed by 50%. Then, the processing of overlapping part of T+1 and t+2 is: (T+1*Window coefficient)+(overlapping part of t+2*window coefficient). The window coefficient of different data in the overlapping part may be different. For example: the data blocks of T+1 is 1-128, and the data blocks of t+2 is 1-256, then the overlapping part of t+2 with T+1 is 1-128, wherein the processing of data 120 may be (120 of T+1)*window coefficient 0.3+(120 of t+2)*window coefficient 0.7, and the processing of data 128 may be (128 of T+1)*window coefficient 0.5+(128 of t+2)*window coefficient 0.5.

The accuracy of two parts of data is improved in the present invention.

1. For the correct time domain data such as T and T+5 that is not adjacent to the lost or error time domain data, by buffering and outputting the correct time domain data directly, it can ensure that there is no loss of accuracy due to the transformation between the time domain and the frequency domain. In the related traditional method shown in FIGS. 2, tt and tt+5 are obtained based on T and T+5 by windowing, FFT transformation and IFFT transformation, and windowing overlap-add. In the embedded fixed-point system, due to the limitation of bit width and computing power, these transformations will definitely cause the loss of accuracy.

2. For the correct time domain data, such as T+1 and T+4 as shown in FIG. 4, adjacent to the lost or error time domain data, the output Tt+1 is obtained by windowing and overlap-adding T+1 and t+2. The output Tt+1 in the traditional method as shown in FIG. 2 is obtained by windowing and overlap-adding t+1 and t+2. If the common part t+2 of the two is not considered, windowing is performed only once when Tt+1 is obtained in the present invention, windowing, FFT, IFFT and windowing is performed in order when tt+1 is obtained in the traditional method, and these transformations in the traditional method will definitely cause the loss of accuracy.

Therefore, accuracy from the following two aspects is improved in the present invention.

1) The traditional method performs FFT and IFFT transformation on all data. In the embedded fixed-point system, due to the limitation of bit width and computing power, these transformations will definitely cause the loss of accuracy, so the accuracy of the present invention is higher.

2) The traditional method performs two windowing operations, while the method in the present invention only performs one windowing (the window coefficient is the product of the window coefficients of the two windowing in the traditional method). In the embedded fixed-point system, due to the limitation of the bit width, the traditional method needs to retain the intermediate result with the limited bit width after the first windowing and round the intermediate result, which brings the loss of accuracy. Therefore, the calculation accuracy of the method of the present invention is higher.

Based on the same inventive concept, an audio data recovery device is also provided according to one embodiment of the present invention. Since the audio data recovery device solves the same problem with similar principle with the audio data recovery method provided in the first embodiment of the present invention, the implementation of the audio data recovery device can refer to the implementation of the method, and the repetition will not be repeated.

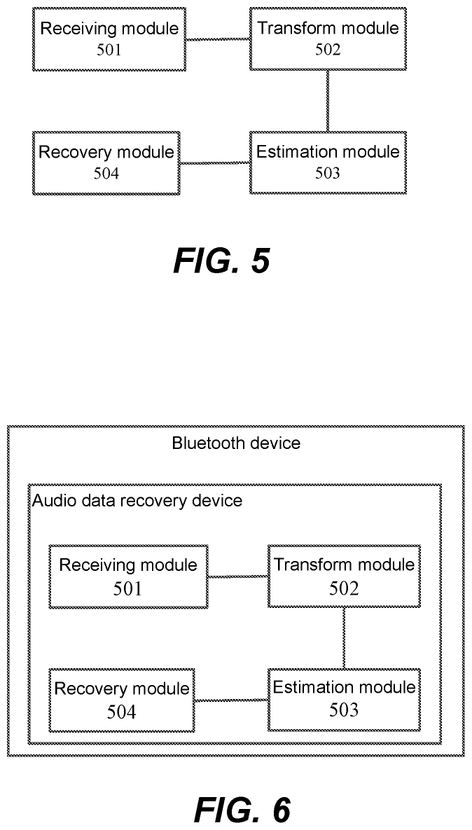

FIG. 5 is a schematic structural diagram of an audio data recovery device according to one embodiment of the present invention. As shown in FIG. 5, the audio data recovery device includes: a receiving module 501 configured for receiving time domain audio data comprising a first type of data and a second type of data; a transform module 502 configured for transforming the time domain audio data into frequency domain audio data; an estimation module 503 configured for performing packet loss concealment estimation on a part, obtained by transforming the second type of data, of the frequency domain audio data to generate estimated frequency domain audio data, and transforming the estimated frequency domain audio data into estimated time domain audio data; and a recovery module 504 configured for obtaining recovered time domain audio data according to the first type of data in the time domain audio data and the estimated time domain audio data.

In the audio data recovery device of the present invention, only a part, obtained by transforming the second type of data, not all of the frequency domain audio data is estimated by packet loss concealment estimation, and an output result with a higher accuracy than the traditional method based on the GAPES algorithm can be obtained by combining a first part of the first type of data in the time domain audio data without any transformation processing and the estimated time domain audio data. It has lower computational complexity than the traditional method.

In one embodiment, the first type of data is correct data packets, and the second type of data is lost or error data packets. The received audio data can be CRC checked firstly. The data packet with correct CRC check is considered as the correct data packet, and the data packet with incorrect CRC check is considered as the error data packet. In addition, some data packets may be lost during transmission.

In one embodiment, the time domain audio data is transformed into the frequency domain audio data through discrete Fast Fourier Transform (FFT). The Gapped-data Amplitude and Phase Estimation (GAPES) algorithm is used to perform the packet loss concealment estimation on the part, obtained by transforming the second type of data, of the frequency domain audio data.

In one embodiment, the recovery module comprises: a first processing unit configured for outputting a first part, not adjacent to the second type of data, of the first type of data in the time domain audio data directly to obtain a first output result; a second processing unit configured for performing an overlap-add OLA on a second part, adjacent to the second type of data, of the first type of data in the time domain audio data and the estimated time domain audio data to obtain and output a second output result; and a third processing unit configured for obtaining the recovered audio data according to the first output result and the second output result.

In one embodiment, the estimated time domain audio data has data blocks, overlapped with the second part of the first type of data, in the time domain audio data and data blocks, not overlapped with the second part of the first type of data, in the time domain audio data. The second processing unit comprises: a first processing subunit configured for performing the overlap-add on the data blocks, overlapped with the second part of the first type of data, in the estimated time domain audio data and the second part of the first type of data to obtain and output a first correct data; a second processing subunit configured for performing the overlap-add among the data blocks to obtain and output a second correct data; and a third processing subunit configured for combining the first correct data and the second correct data according to data serial number to obtain the second output result.

In one embodiment, the first processing subunit is configured for: multiplying the second part of the first type of data in the time domain audio data by a first window coefficient to obtain a first data; multiplying the data blocks, overlapped with the second part of the first type of data, in the estimated time domain audio data by a second window coefficient to obtain a second data; and adding the first data obtained by multiplying the first window coefficient and the second data obtained by multiplying the second window coefficient to obtain the first correct data.

Based on the same inventive concept, a Bluetooth device is provided according to one embodiment of the present invention. Since the Bluetooth device solves the same problem with similar principle with the method provided in the first embodiment of the present invention, the implementation of the Bluetooth device can refer to the method can refer to the implementation of the method, and the repetition will not be repeated.

FIG. 6 is a schematic structural diagram of a Bluetooth device according to one embodiment of the present invention. As shown in FIG. 6, the Bluetooth device includes: an audio data recovery device shown in FIG. 5.

The Bluetooth device may be a Bluetooth headset, a Bluetooth speaker, a Bluetooth gateway, a Bluetooth MP3, a Bluetooth flash disk, a Bluetooth vehicle-mounted device, a Bluetooth adapter, etc., which are not limited in the present disclosure.

The Bluetooth device provided according to one embodiment of the present invention buffers the correct data packets, and finally combines and overlap-adds the buffered data packets and the estimated frequency domain data to obtain the output result with higher accuracy than that of the traditional method. Furthermore, it has lower computational complexity than the traditional method.

According to one aspect of the present invention, the present invention can be implemented as a nonvolatile computer-readable medium. The nonvolatile computer-readable medium comprises instructions executed by a processor. The instructions cause the processor to perform: capturing ambient sound; detecting the ambient sound, and triggering the headphone to enter an interactive mode when a preset interested sound appears in the ambient sound; controlling the headphone to output an interactive reminder in the interactive mode. The interactive reminder comprises one type or a combination of multiple types of a visual reminder, a tactile reminder and an auditory reminder.

Those skilled in the art should be aware that the embodiments of this application may be methods, systems, or computer program products. Accordingly, the present application may take the form of a complete hardware embodiment, a complete software embodiment, or an embodiment in conjunction with software and hardware aspects. Furthermore, the present application may take the form of a computer program product implemented on one or more computer-available storage media (including, but not limited to, disk memory, CD-ROM, optical memory, etc.) containing computer-available program code.

The present application is described with reference to methods, equipment (systems), and flow charts and/or block diagrams of computer program products according to the embodiment of the present application. It should be understood that each flow and/or block in a flowchart and/or block diagram, as well as the combination of flow and/or block in a flowchart and/or block diagram, can be implemented by computer program instructions. These computer program instructions may be provided to a processor of a general purpose computer, a dedicated computer, an embedded processor, or other programmable data processing device to produce a machine such that instructions executed by a processor of a computer or other programmable data processing device produce instructions for implementing a flow chart or more. A device for processes and/or block diagrams or functions specified in a box or multiple boxes.

These computer program instructions may also be stored in a computer-readable memory that may guide a computer or other programmable data processing device to work in a particular way, such that the instructions stored in the computer-readable memory generate a manufacturer including an instruction device that is implemented in a flow chart one or more processes. Process and/or block diagram, a box or function specified in multiple boxes.

These computer program instructions may also be loaded on a computer or other programmable data processing device such that a series of operational steps are performed on a computer or other programmable device to produce computer-implemented processing, thereby providing instructions executed on a computer or other programmable device for implementing a flow chart. The steps of a process or multiple processes and/or block diagrams, or functions specified in a box.

Although preferred embodiments of the present application have been described, additional changes and modifications to these embodiments may be made once the basic creative concepts are known to those skilled in the art. The appended claims are therefore intended to be interpreted to include preferred embodiments and all changes and modifications falling within the scope of this application.

Obviously, a person skilled in the art may make various changes and variations to the application without departing from the spirit and scope of the application. Thus, if these modifications and variations of this application fall within the scope of the claims and their equivalent technologies, the application is also intended to include these changes and variations.

We claim:

1. An audio data recovery method, comprising:
receiving audio data in time domain, the audio data including a first type of data and a second type of data;
transforming the audio data from the time domain into frequency domain to produce transformed first type of data and transformed second type of data;
performing packet loss concealment estimation on the transformed second type of data to generate estimated second type of data in the frequency domain;
transforming inversely the transformed first type of data together with the estimated second type of data from the frequency domain to the time domain; and
obtaining recovered audio data in the time domain according to the first type of data in the audio data in the time domain and the estimated second type of data in the time domain.

2. The audio data recovery method according to claim 1, wherein the first type of data is correct data packets, and the second type of data is lost or error data packets.

3. The audio data recovery method according to claim 1, wherein said obtaining recovered audio data in the time domain according to the first type of data in the audio data in the time domain and the estimated second type of data in the time domain comprising:
outputting a first part, not adjacent to the second type of data, of the first type of data in the time domain audio data directly as a first output result;
performing an overlap-add OLA on a second part, adjacent to the second type of data, of the first type of data in the time domain audio data and the estimated time domain audio data to obtain and output a second output result; and
obtaining the recovered audio data according to the first output result and the second output result.

4. The audio data recovery method according to claim 3, wherein the estimated second type of data has data blocks overlapped with the second part of the first type of data and data blocks not overlapped with the second part of the first type of data, and
the performing an overlap-add OLA on a second part, adjacent to the second type of data, of the first type of data in the time domain audio data and the estimated time domain audio data to obtain and output a second output result comprises:
performing the overlap-add on the data blocks, overlapped with the second part of the first type of data, in the estimated time domain audio data and the second part of the first type of data to obtain and output a first correct data;
performing the overlap-add among the data blocks in the estimated time domain audio data to obtain and output a second correct data; and
combining the first correct data and the second correct data according to data serial number to obtain the second output result.

5. The audio data recovery method according to claim 4, wherein the performing the overlap-add on the data blocks, overlapped with the second part of the first type of data, in the estimated time domain audio data and the second part of the first type of data to obtain and output a first correct data comprises:
multiplying the second part of the first type of data in the time domain audio data by a first window coefficient to obtain a first data;
multiplying the data blocks, overlapped with the second part of the first type of data, in the estimated time domain audio data by a second window coefficient to obtain a second data; and
adding the first data obtained by multiplying the first window coefficient and the second data obtained by multiplying the second window coefficient to obtain the first correct data.

6. An audio data recovery device, comprising:
a receiving module configured for receiving time domain audio data comprising a first type of data and a second type of data;
a transform module transforming the time domain audio data into frequency domain audio data;
an estimation module performing packet loss concealment estimation on a part, obtained by transforming the second type of data, of the frequency domain audio data to generate estimated frequency domain audio data, and transforming the estimated frequency domain audio data into estimated time domain audio data; and
a recovery module configured for obtaining recovered time domain audio data according to the first type of data in the time domain audio data and the estimated time domain audio data.

7. The audio data recovery device according to claim 6, wherein the first type of data is correct data packets, and the second type of data is lost or error data packets.

8. The audio data recovery device according to claim 6, wherein the recovery module comprises:
a first processing unit configured for outputting a first part, not adjacent to the second type of data, of the first type of data in the time domain audio data as a first output result directly;
a second processing unit configured for performing an overlap-add OLA on a second part, adjacent to the second type of data, of the first type of data in the time domain audio data and the estimated time domain audio data to obtain and output a second output result; and
a third processing unit configured for obtaining the recovered audio data according to the first output result and the second output result.

9. The audio data recovery device according to claim 8, wherein the estimated time domain audio data has data blocks overlapped with the second part of the first type of data and data blocks not overlapped with the second part of the first type of data, and
the second processing unit comprises:
a first processing subunit configured for performing the overlap-add on the data blocks, overlapped with the second part of the first type of data, in the estimated time domain audio data and the second part of the first type of data to obtain and output a first correct data;
a second processing subunit configured for performing the overlap-add among the data blocks in the estimated time domain audio data to obtain and output a second correct data; and
a third processing subunit configured for combining the first correct data and the second correct data according to data serial number to obtain the second output result.

10. The audio data recovery device according to claim 9, wherein the first processing subunit is configured for:
multiplying the second part of the first type of data in the time domain audio data by a first window coefficient to obtain a first data;
multiplying the data blocks, overlapped with the second part of the first type of data, in the estimated time domain audio data by a second window coefficient to obtain a second data; and
adding the first data obtained by multiplying the first window coefficient and the second data obtained by multiplying the second window coefficient to obtain the first correct data.

11. A Bluetooth device, comprising:
an audio data recovery device, comprising:
a receiving module configured for receiving time domain audio data comprising a first type of data and a second type of data;
a transform module configured for transforming the time domain audio data into frequency domain audio data;
an estimation module configured for performing packet loss concealment estimation on a part, obtained by transforming the second type of data, of the frequency domain audio data to generate estimated frequency domain audio data, and transforming the estimated frequency domain audio data into estimated time domain audio data; and
a recovery module configured for obtaining recovered time domain audio data according to the first type of data in the time domain audio data and the estimated time domain audio data.

12. The Bluetooth device according to claim 11, wherein the first type of data is correct data packets, and the second type of data is lost or error data packets.

13. The Bluetooth device according to claim 11, wherein the recovery module comprises:
a first processing unit configured for outputting a first part, not adjacent to the second type of data, of the first type of data in the time domain audio data directly as a first output result directly;
a second processing unit configured for performing an overlap-add OLA on a second part, adjacent to the second type of data, of the first type of data in the time domain audio data and the estimated time domain audio data to obtain and output a second output result; and
a third processing unit configured for obtaining the recovered audio data according to the first output result and the second output result.

14. The Bluetooth device according to claim 13, wherein the estimated time domain audio data has data blocks overlapped with the second part of the first type of data and data blocks not overlapped with the second part of the first type of data, and
the second processing unit comprises:
a first processing subunit configured for performing the overlap-add on the data blocks, overlapped with the second part of the first type of data, in the estimated time domain audio data and the second part of the first type of data to obtain and output a first correct data;
a second processing subunit configured for performing the overlap-add among the data blocks in the estimated time domain audio data to obtain and output a second correct data; and
a third processing subunit configured for combining the first correct data and the second correct data according to data serial number to obtain the second output result.

15. The Bluetooth device according to claim 14, wherein the first processing subunit is configured for:
multiplying the second part of the first type of data in the time domain audio data by a first window coefficient to obtain a first data;
multiplying the data blocks, overlapped with the second part of the first type of data, in the estimated time domain audio data by a second window coefficient to obtain a second data; and
adding the first data obtained by multiplying the first window coefficient and the second data obtained by multiplying the second window coefficient to obtain the first correct data.
